(19) United States
(12) Patent Application Publication
(10) Pub. No.: US 2025/0073825 A1
(43) Pub. Date: Mar. 6, 2025

(54) IMPROVEMENTS IN AND RELATING TO WELDING AND QUALITY CONTROL

(71) Applicant: CAVENDISH NUCLEAR LIMITED, Birchwood (GB)

(72) Inventors: Randika Kosala Wathavana VITHANAGE, Glasgow (GB); Charles Norman MACLEOD, Glasgow (GB); David Ian Arthur LINES, Glasgow (GB); Matt SMART, Catcliffe (GB); Paul SMART, Catcliffe (GB); Ryan SWAIN, Catcliffe (GB); Tim ROOKER, Catcliffe (GB); Jeyaganesh BALAKRISHNAN, Catcliffe (GB); Xuanang LIU, Catcliffe (GB)

(21) Appl. No.: 18/721,656

(22) PCT Filed: Dec. 22, 2022
(86) PCT No.: PCT/GB2022/053358

§ 371 Date: Jun. 18, 2024

(30) Foreign Application Priority Data
Dec. 22, 2021 (GB) 2118771.1

(51) Int. Cl. B23K 31/12; B23K 31/02

(52) U.S. Cl. CPC B23K 31/125; B23K 31/02

(57) ABSTRACT

A method of welding and apparatus for implementing the method are provided which employ inspection of a weld formed by the method of welding. The inspecting of the weld is provided by the inspection apparatus at an inspection location on the one or more welded substrates, with the inspection location at an elevated temperature above ambient, for instance wherein the elevated temperature is at least 180° C. above ambient or even at least 350° C. above ambient. In this way the inspection can be performed without the substrate needing to cool and faster inspection and faster weld remediation times are achieved.

This disclosure concerns improvements in and relating to welding, quality control in welding and to methods of use thereof, in non-destructive ultrasound testing, particularly but not exclusively in relation to high temperature deployments thereof.

Ultrasonic testing is used for the non-destructive testing of a wide variety of objects. A transmitting transducer emits ultrasound waves which enter the object, interact with the object and sub-features thereof, and then return to a receiving transducer. Effective transmission of the ultrasound into the object is important, to avoid high levels of reflection at the interface. A liquid coupler is often used to improve transmission at the interface.

When testing welds, after completion of the weld or after each individual weld pass or after each weld layer, it is desirable to be able to conduct the ultrasound test soon after the weld or weld pass or weld layer has been formed, so as to minimise the time taken to perform, test and then make any corrections needed to the weld or weld pass or weld layer. However, liquid couplers such as water, have clear limits on the temperatures of object that they can operate on and so the object piece has to cool to a material extent before testing in such cases. If correction is needed, then the object then has to be brought up to temperature again.

Amongst the potential aims of the disclosure is to provide a method of welding and verification of quality in which the verification is conducted at higher temperatures and without the need for cooling first. Amongst the potential aims of the disclosure is to provide a method of welding and verification of welding conditions that can be conducted in real time and provide further control of the welding process.

According to a first aspect of the disclosure there is provided a method of welding, the method of welding including inspection of a weld formed by the method of welding, the method of welding comprising:
i. providing welding apparatus;
ii. providing weld inspection apparatus;
iii. introducing one of more substrates to be welded to the welding apparatus;
iv. elevating the temperature of the one or more substrates above ambient temperature using heating;
v. conducting welding of the one or more substrates at an elevated temperature above ambient temperature using the welding apparatus;
vi. inspecting the weld generated using the weld inspection apparatus;
wherein the inspecting of the weld is provided by the inspection apparatus at an inspection location on the one or more substrates, with the inspection location at an elevated temperature above ambient.

The method may be arc welding.

The method may include inspection of the whole weld. The method may include the inspection of a multi-pass weld, for instance before all of the passes have been completed, such as after each pass and before the next pass.

The welding apparatus may be mounted on any autonomous automated deployment system. The welding apparatus may be mounted on a guided rail system or column and boom system. The welding apparatus may be mounted on a robotic arm, for instance a multi-axis arm. The welding apparatus may be an arc welder.

The weld inspection apparatus may use ultrasound. The weld inspection apparatus may be mounted on any autonomous automated deployment system. The weld inspection apparatus may be mounted on a guided rail system or column and boom system. The weld inspection apparatus may be mounted on a robotic arm, for instance a multi-axis arm. The weld inspection apparatus may be a phased array ultrasound transducer. The weld inspection apparatus may include an ultrasound emitter and a receiver. The weld inspection apparatus may include a substrate contacting surface. The weld inspection apparatus may be in physical contact with the inspection location. The substrate contacting surface may be in physical contact with the inspection location.

The method may include rolling the weld inspection apparatus, for instance the substrate contact surface thereof, over the surface of the substrate, for instance to one side of, but potentially parallel to the weld.

The weld inspection apparatus may be provided with internal cooling. The method may include the feeding of coolant into the weld inspection apparatus and/or the removal of coolant from the weld inspection apparatus.

The method may provide that the inspecting of the weld is provided with the inspection location at an elevated temperature above ambient, and wherein the elevated temperature is at least 80° C. above ambient. The method may provide that the inspecting of the weld is provided with the inspection location at an elevated temperature above ambient, and wherein the elevated temperature is at least 180° C. above ambient. The method may provide that the inspecting of the weld is provided with the inspection location at an elevated temperature above ambient, and wherein the elevated temperature is at least 250° C. above ambient. The method may provide that the inspecting of the weld is provided with the inspection location at an elevated temperature above ambient, and wherein the elevated temperature is at least 300° C. above ambient. The method may provide that the inspecting of the weld is provided with the inspection location at an elevated temperature above ambient, and wherein the elevated temperature is at least 350° C. above ambient. The method may provide that ambient is 20° C.+/−10° C.

The method may provide that the inspecting of the weld is provided without any cooling time for the one or more substrates below the elevated temperature. The method may provide that the inspecting of the weld is provided with heating still applied to the one or more substrates, for instance pre-heating.

The method may provide that the duration of the inspecting of the weld is conducted over an equivalent time period to that over which the welding is conducted. The inspecting of the weld time period may start after the welding time period. The inspecting of the weld time period may overlap with the welding time period, potentially with an overlap of at least 50% of the inspecting of the weld time period, or even at least 80%, or even at least 90%.

The method may provide that the welding is conducted at a welding location when inspecting is conducted at the inspection location, wherein the welding location and the inspection location are less than 2 m apart along the weld. The method may provide that the welding is conducted at a welding location when inspecting is conducted at the inspection location, wherein the welding location and the inspection location are less than 1 m apart along the weld. The method may provide that the welding is conducted at a welding location when inspecting is conducted at the inspection location, wherein the welding location and the inspection location are less than 0.5 m apart along the weld. The method may provide that the welding is conducted at a welding location when inspecting is conducted at the inspection location, wherein the welding location and the inspection location are less than 0.25 m apart along the weld. The method may provide that the welding is conducted at a welding location when inspecting is conducted at the inspection location, wherein the welding location and the inspection location are less than 0.15 m apart along the weld, potentially 0.1 m.

The method may provide that the welding is conducted at a welding location when inspecting is conducted at the inspection location, wherein the inspecting location was a welding location less than 10 minutes previously. The method may provide that the welding is conducted at a welding location when inspecting is conducted at the inspection location, wherein the inspecting location was a welding location less than 5 minutes previously. The method may provide that the welding is conducted at a welding location when inspecting is conducted at the inspection location, wherein the inspecting location was a welding location less than 3 minutes previously.

The method may provide that welding is conducted at a welding location and the welding location is at a temperature of at 800° C. during welding.

The method may provide that the elevating the temperature of the one or more substrates above ambient temperature provides the one or more substrates at a temperature of at least 110° C. The method may provide that the elevating the temperature of the one or more substrates above ambient temperature provides the one or more substrates at a temperature of at least 180° C. The method may provide that the elevating the temperature of the one or more substrates above ambient temperature provides the one or more substrates at a temperature of at least 250° C. The method may provide that the elevating the temperature of the one or more substrates above ambient temperature provides the one or more substrates at a temperature of at least 300° C. The method may provide that the elevating the temperature of the one or more substrates above ambient temperature provides the one or more substrates at a temperature of at least 350° C. The method may provide that the elevating the temperature of the one or more substrates above ambient temperature is provided by pre-heating the one or more substrates before welding starts.

The method may provide that the defect location is detected with an accuracy to within 15 mm of the actual defect location, potentially within 10 mm, possibly within 5 mm and even within 1 mm.

The method may provide that the characteristics include one or more of size, position, defect type, defect shape or defect position relative to the geometry of the weld and/or relative to the length of weld.

The method may provide that wherein if the inspecting indicates a defect in the weld at a defect location, one or more remedial steps are taken on the weld at the defect location. One of the remedial steps may be the removal of a part of the weld, for instance excavating a part of the weld. One of the remedial steps, for instance after removal of a part of the weld, may be a further inspection at an inspection location where a remedial step has been taken. The further inspection may establish that the defect has been removed or that further remedial steps are needed, for instance the removal of a further part of the weld. One of the remedial steps, for instance after establishing that the defect has been removed, may be re-welding. The method may include re-welding at the defect location and/or where a part of the weld has been removed.

The method may provide that the remedial step[s] are provided with the defect location at an elevated temperature above ambient. The method may provide that the elevated temperature is at least 80° C. above ambient, possibly at least 180° C. above ambient, and potentially at least 250° C. above ambient. The method may provide that the elevated temperature is at least 300° C. above ambient, possibly at least 325° C. above ambient, and potentially at least 350° C. above ambient. The method may provide that all of the remedial steps are taken with the defect location at an elevated temperature above ambient.

According to a second aspect of the disclosure there is provided apparatus for conducting a method of welding including inspection of a weld formed by the method of welding on a substrate, the apparatus comprising:
i. welding apparatus;
ii. weld inspection apparatus, wherein the weld inspection apparatus includes an ultrasound emitter and receiver, the weld inspecting apparatus is provided with a substrate contact surface, wherein the substrate contact surface has a melting temperature above 250° C.

The weld inspection apparatus may use ultrasound. The weld inspection apparatus may be mounted on any autonomous automated deployment system. The weld inspection apparatus may be mounted on a guided rail system or column and boom system. The weld inspection apparatus may be mounted a robotic arm, for instance a multi-axis arm. The weld inspection apparatus may be a phased array ultrasound transducer. The weld inspection apparatus may include an ultrasound emitter and a receiver. The weld inspection apparatus may include a substrate contacting surface.

The weld inspection apparatus may be adapted to be provided in physical contact with the inspection location. The substrate contacting surface may be adapted to be provided in physical contact with the inspection location.

The weld inspection apparatus, for instance the substrate contact surface thereof, may be adapted to roll over the surface of the substrate, for instance to one side of, but potentially parallel to the weld.

The weld inspection apparatus may be provided with internal cooling. The ultrasound emitter and the receiver may be provided in weld inspection apparatus that is provided with internal cooling. The weld inspection apparatus may include an inlet for coolant leading into the weld inspection apparatus and/or an outlet for coolant leading out of the weld inspection apparatus.

The first aspect of the disclosure may include any of the features or possibilities or options set out elsewhere in the document, including in the other aspects of the disclosure.

According to a third aspect of the disclosure there is provided a method of welding, the method of welding comprising:
a) providing welding apparatus;
b) providing a plurality of sensor types;
c) defining a first set of welding conditions for the welding method;
d) introducing one of more substrates to be welded to the welding apparatus;
e) conducting welding of the one or more substrates;
f) obtaining data from the plurality of sensor types during welding;
g) comparing the obtained data from the plurality of sensor types with reference data for one or more of the sensor types;
h) based upon one or more such comparisons, determining whether the welding is of acceptable quality or unacceptable quality;
i) where, if the welding is of unacceptable quality, the method includes then taking one or more actions.

The third aspect of the disclosure may include any of the features or possibilities or options set out in the first and/or second aspect of the disclosure relating to the inspection of a weld.

The method of welding may further include: inspection of a weld formed by the method of welding. The method of welding may further comprise:
i. providing weld inspection apparatus;
ii. elevating the temperature of the one or more substrates above ambient temperature using heating;
iii. conducting welding of the one or more substrates at an elevated temperature above ambient temperature using the welding apparatus;
iv. inspecting the weld generated using the weld inspection apparatus;
v. wherein the inspecting of the weld is provided by the inspection apparatus at an inspection location on the one or more substrates, with the inspection location at an elevated temperature above ambient.

The method may be arc welding.

The method may include inspection of the whole weld. The method may include the inspection of a multi-pass weld, for instance before all of the passes have been completed, such as after each pass and before the next pass.

The welding apparatus may be mounted on any autonomous automated deployment system. The welding apparatus may be mounted on a guided rail system or column and boom system. The welding apparatus may be mounted on a robotic arm, for instance a multi-axis arm. The welding apparatus may be an arc welder.

The weld inspection apparatus may use ultrasound. The weld inspection apparatus may be mounted on any autonomous automated deployment system. The welding apparatus may be mounted on a guided rail system or column and boom system. The welding apparatus may be mounted on a robotic arm, for instance a multi-axis arm. The weld inspection apparatus may be a phased array ultrasound transducer. The weld inspection apparatus may include an ultrasound emitter and a receiver. The weld inspection apparatus may include a substrate contacting surface. The weld inspection apparatus may be in physical contact with the inspection location. The substrate contacting surface may be in physical contact with the inspection location.

The method may include rolling the weld inspection apparatus, for instance the substrate contact surface thereof, over the surface of the substrate, for instance to one side of, but potentially parallel to the weld.

The weld inspection apparatus may be provided with internal cooling. The method may include the feeding of coolant into the weld inspection apparatus and/or the removal of coolant from the weld inspection apparatus.

The method may further provide that at least one sensor type of the plurality of sensor types is a part of weld inspection apparatus and the method includes a step of inspecting the weld using the weld inspection apparatus. The method may provide that the method includes a step of inspecting the weld using weld inspection apparatus to determine one or more characteristics of a defect. The method may provide that the characteristics include one or more of size, position, defect type, defect shape or defect position relative to the geometry of the weld and/or relative to the length of weld.

The method may provide that the method further includes a comparison of one or more of the characteristics with one or more standards, and further includes a determination of whether the weld with the defect meets a weld standard or does not meet the weld standard.

The method may provide that if the weld meets the weld standard, then a record for the weld is created and stored, potentially with the position of the defect relative to the geometry of the weld and/or relative to the length of weld included. The method may provide that the method further includes that the record includes data from one or more of the plurality of sensor types. The method may provide that if the weld does not meet the weld standard, one or more remedial steps are applied to the weld.

The method may provide that at least two sensor types of the plurality of sensor types are weld conditions sensors and the method includes a step of inspecting the weld conditions using the weld condition sensors.

The method may provide that the method includes a step of inspecting the weld conditions to determine one or more parameters of the weld as it is formed.

The method may provide that the method includes a comparison of one or more of the parameter with one or more control parameters, and further includes a determination of whether a risk level for weld defects is exceeded.

The method may provide that the method includes the one or more actions being to alter the welding conditions from the first set of welding conditions for the welding method. The method may provide that the method includes the alteration in the welding conditions from the first set of welding conditions is to stop welding and/or alert an operator. The method may provide that the method includes the alteration in the welding conditions from the first set of welding conditions is to change the welding conditions back to the first set of conditions and/or to change the welding conditions to a second set of conditions.

The method may provide that the method includes at least two of the sensor types are selected from: voltage sensors, current sensors, welding arc sound emission sensors, weld topology sensors, weld imaging sensors and ultrasound imaging sensors.

The third aspect of the disclosure may include any of the features or possibilities or options set out elsewhere in the document, including in the other aspects of the disclosure.

According to a fourth aspect of the disclosure there is provided apparatus for monitoring welding, the apparatus comprising:
a) a plurality of sensor types;
b) a control unit for receiving a first set of welding conditions for the welding method;
c) a comparator for receiving and comparing data from the plurality of sensor types and reference data for one or more of the sensor types;
wherein the comparator outputs a determination on whether the welding is of acceptable quality or unacceptable quality based upon the compared data; and wherein, if the determination is that the welding is of unacceptable quality, the apparatus further provides a control signal to trigger one or more actions by the apparatus.

The apparatus may provide that the apparatus includes weld inspection apparatus to determine one or more characteristics of a defect. The apparatus may provide that the apparatus further provides the comparator includes a first comparator for receiving and comparing one or more of the characteristics with one or more standards, and wherein the first comparator outputs a first determination on whether the weld with the defect meets a weld standard or does not meet the weld standard. The apparatus may provide that the apparatus further provides the comparator includes a second comparator for receiving and comparing one or more of the parameters of the weld as it is formed with one or more control parameters, and wherein the second comparator outputs a second determination on whether a risk level for weld defects is exceeded. The apparatus may provide that if a risk level for weld defects is exceeded that a control signal provided by the apparatus is sent to a controller to trigger one or more actions, and wherein the one or more actions is to alter the welding conditions from the first set of welding conditions for the welding method, for instance, to stop welding and/or alert an operator.

The fourth aspect of the disclosure may include any of the features or possibilities or options set out elsewhere in the document, including in the other aspects of the disclosure.

Various embodiments of the disclosure will now be described, by way of example only, and with reference to the accompanying drawings, in which:

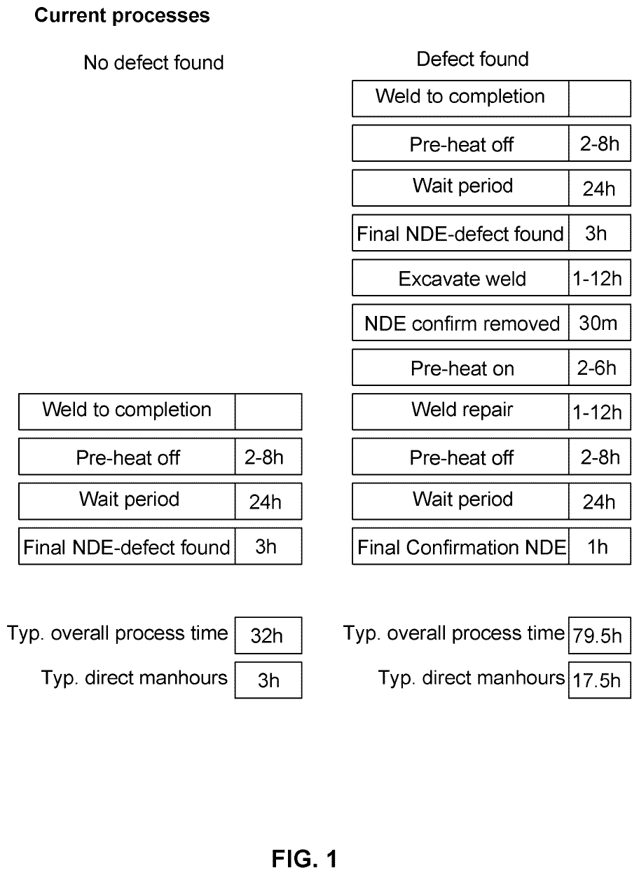

FIG. 1 is a schematic of a process sequence according to an example of the prior art;

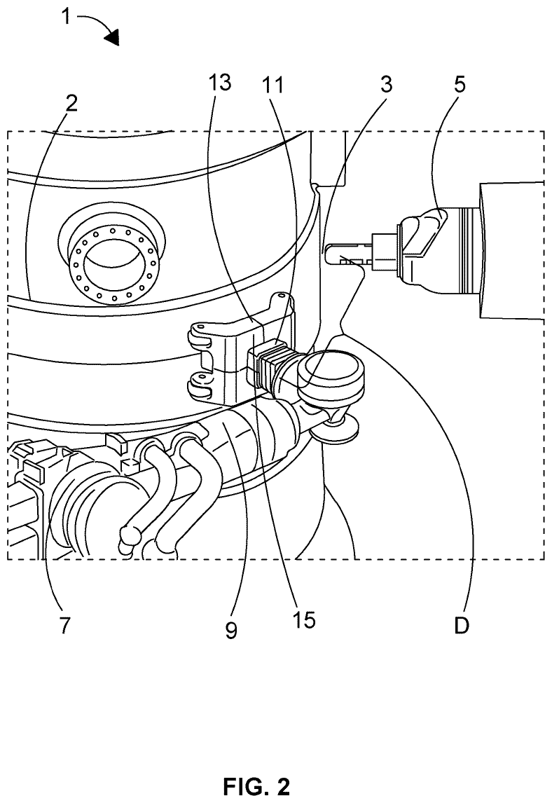

FIG. 2 is a perspective view of a desired environment of use for the disclosure;

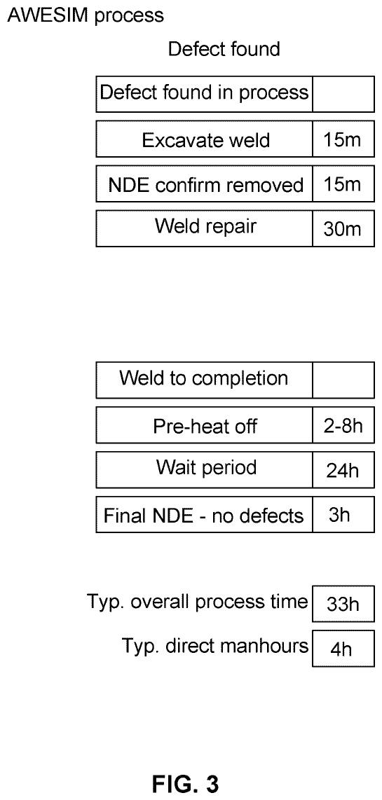

FIG. 3 is a schematic of a process sequence according to the disclosure;

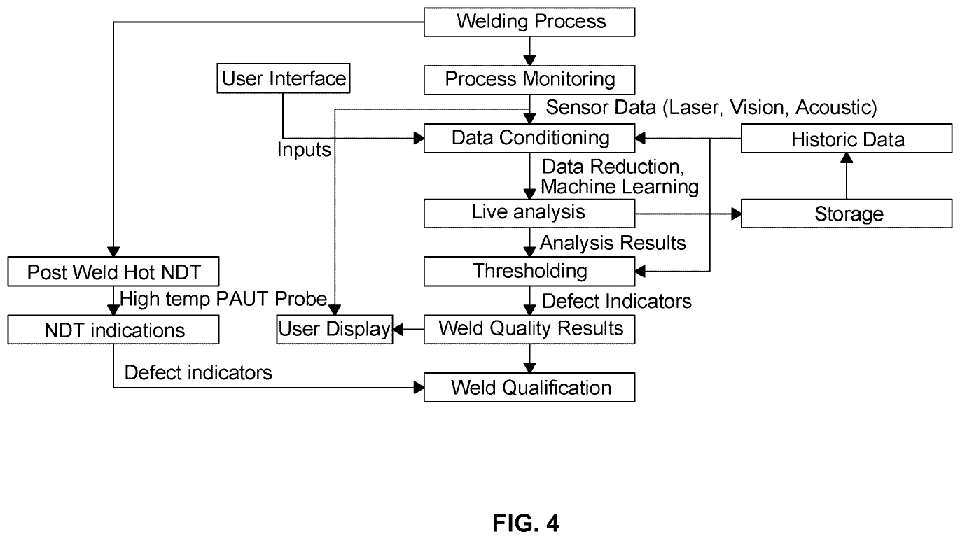

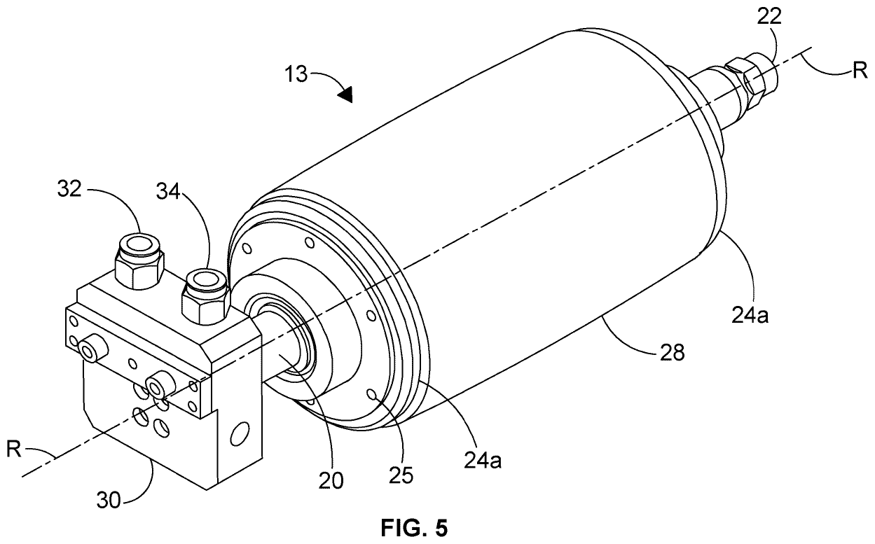

FIG. 4 is a schematic illustration of an adaptive control capability for welding processes contributed to by the disclosure;

FIG. 5 is a perspective view of a probe according to a first embodiment of the disclosure;

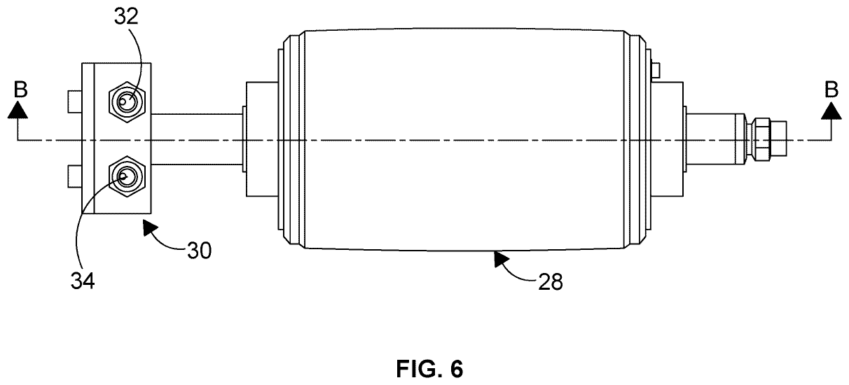

FIG. 6 is a plan view of the probe of FIG. 5;

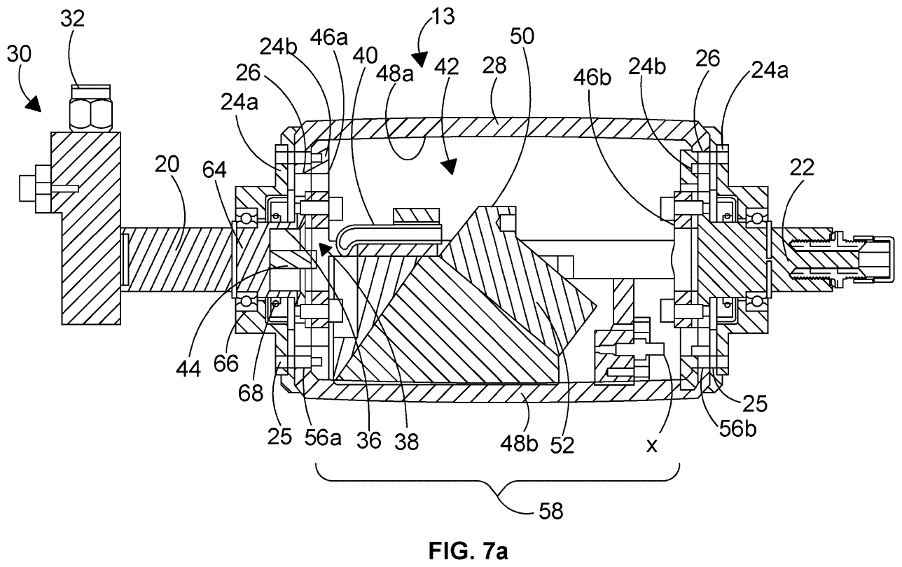

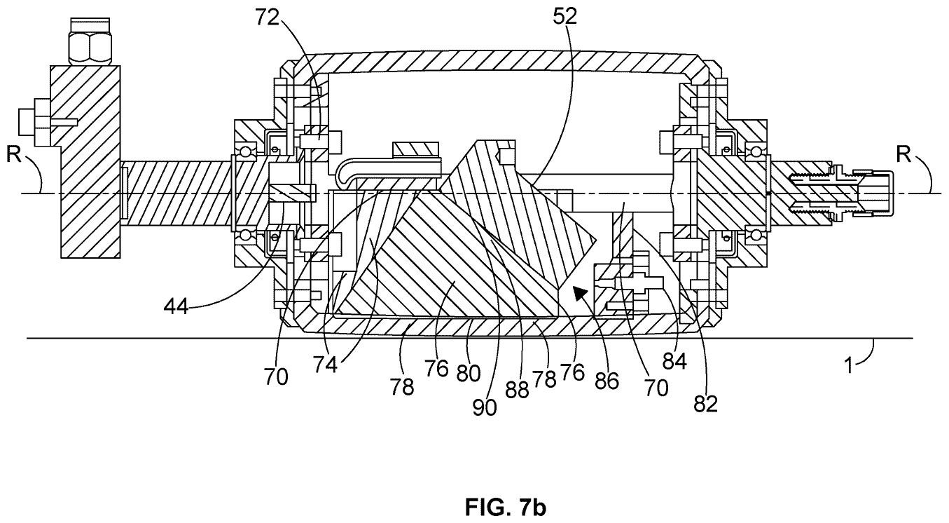

FIG. 7a is a cross-sectional side view of the probe of FIG. 6 on plane B-B;

FIG. 7b is the same view as FIG. 7a, but illustrating further features;

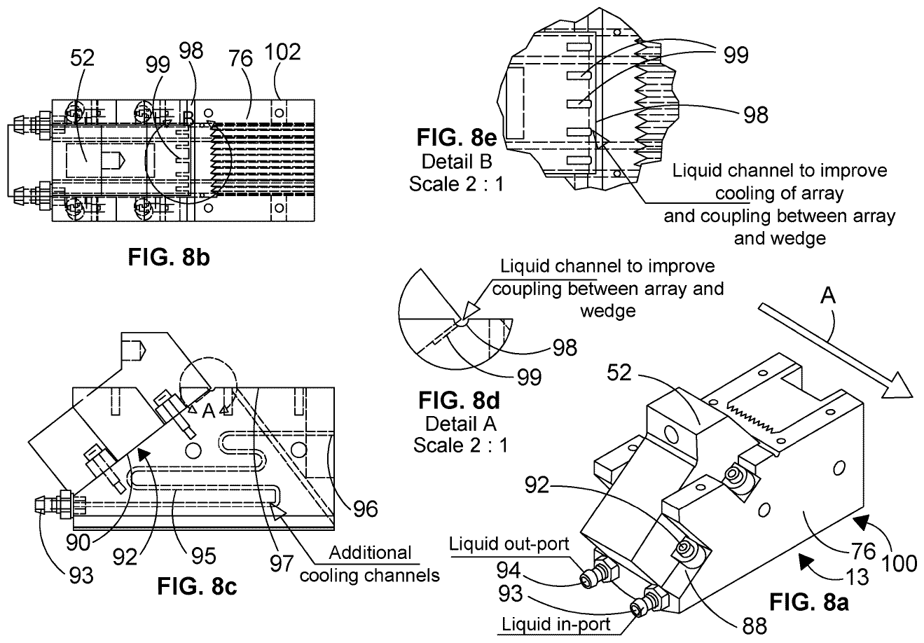

FIG. 8a is perspective view of a probe and conveying block;

FIG. 8b is a top plan view of the probe and conveying clock of FIG. 8a;

FIG. 8c is a side view of the probe and conveying block of FIG. 8a;

FIG. 8d is a side view detail of the top part of the interface between the probe and the conveying block;

FIG. 8e is a top plan detail of the same location as FIG. 8d;

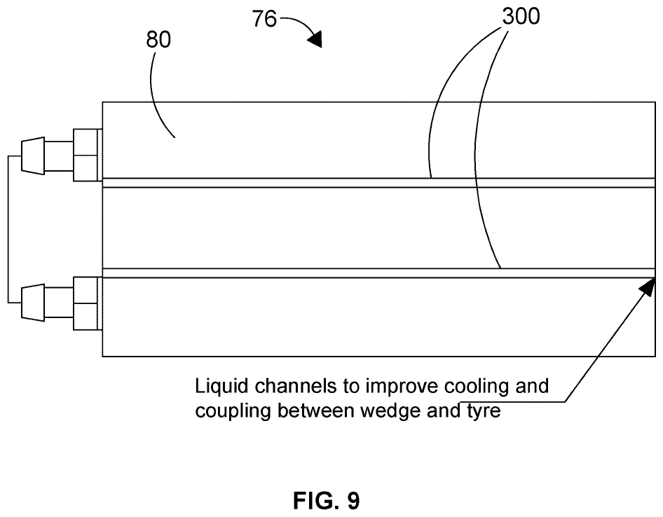

FIG. 9 is a view of the lower surface of the conveying block which faces the compliant element;

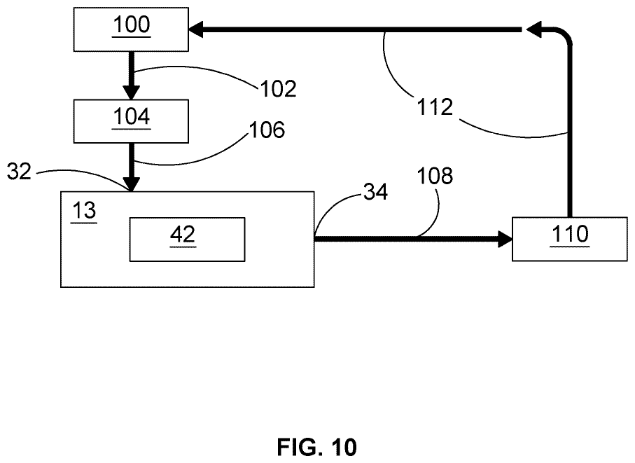

FIG. 10 is a schematic of a cooling circuit for use with a probe according to the disclosure;

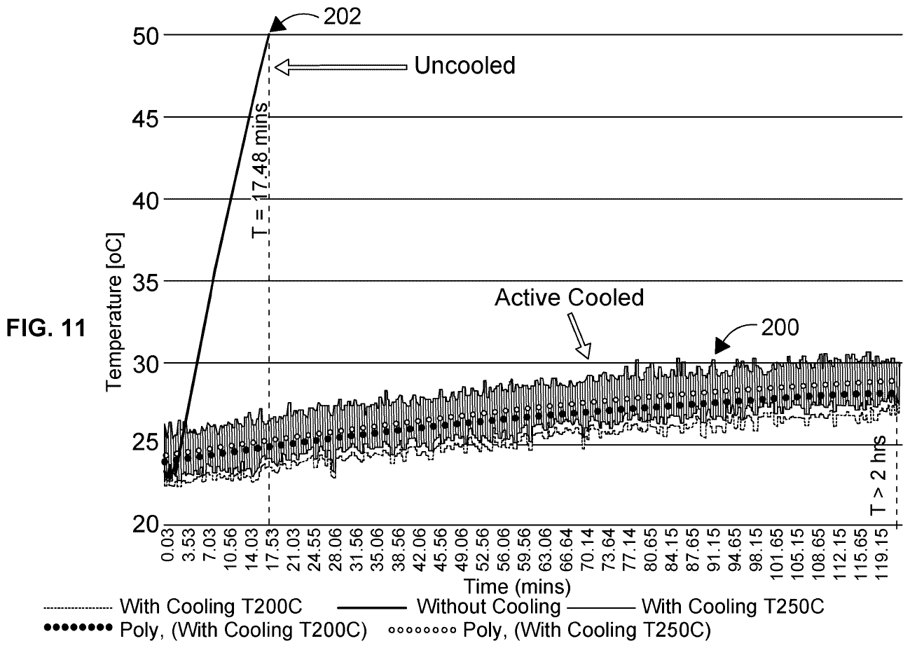

FIG. 11 is a temperature plot of an active cooled probe according to the disclosure compared with a fixed coolant volume probe;

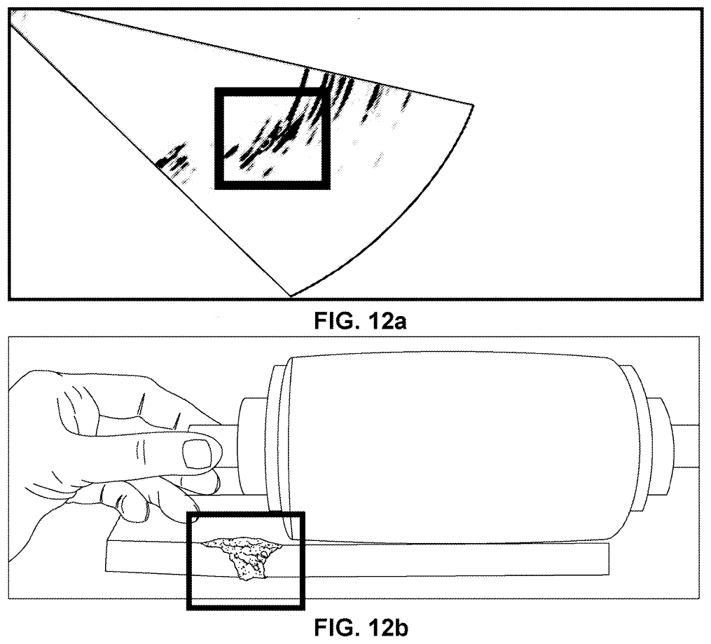

FIG. 12a is an image of an ultrasound probe detected defect;

FIG. 12b is an image of the ultrasound probe used in the detection of FIG. 12a;

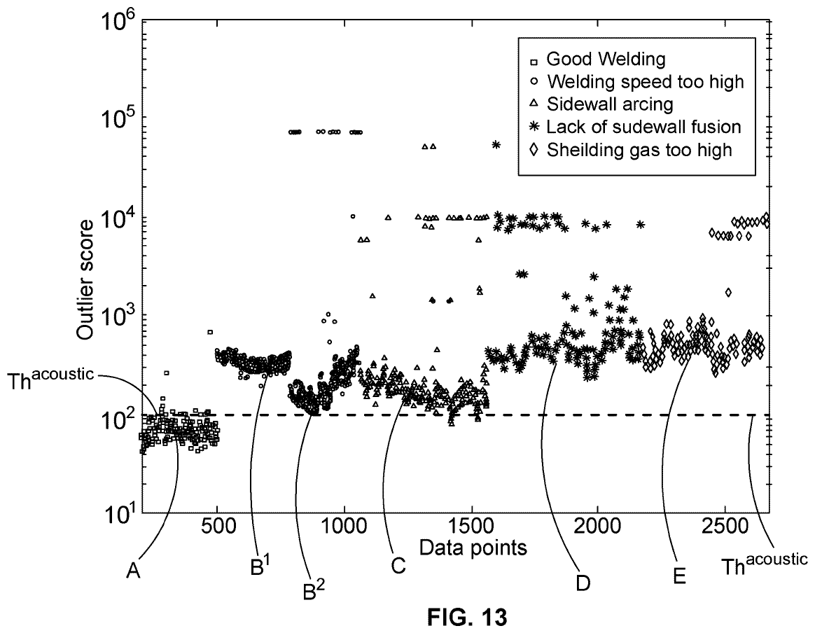

FIG. 13 is a plot of outlier score obtained from acoustic signals v data point for a variety of different welding conditions;

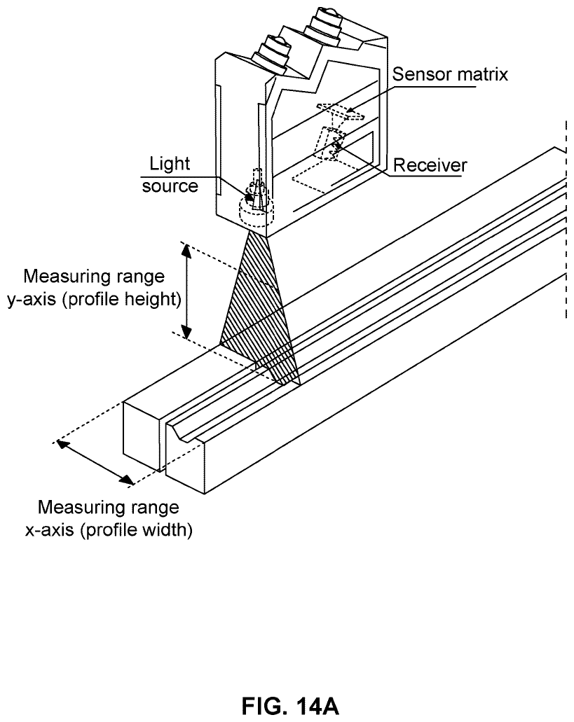

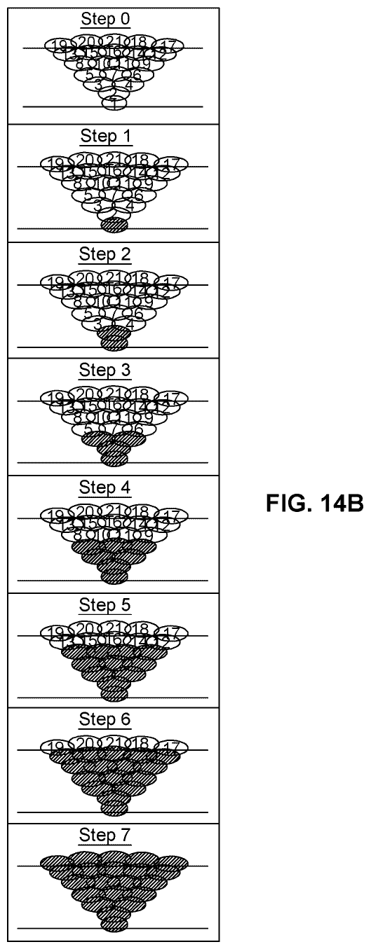

FIG. 14a is a perspective view of a profile sensing device relative to a substrate and weld;

FIG. 14b is a schematic illustration of the sequence and geometry of the formation of an overall weld through a series of weld passes;

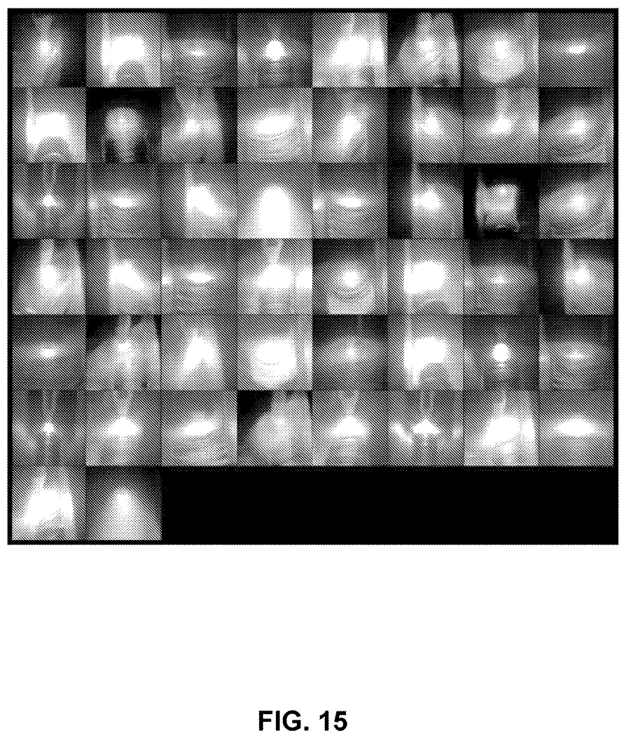

FIG. 15 is a series of camera images of a welding location during welding;

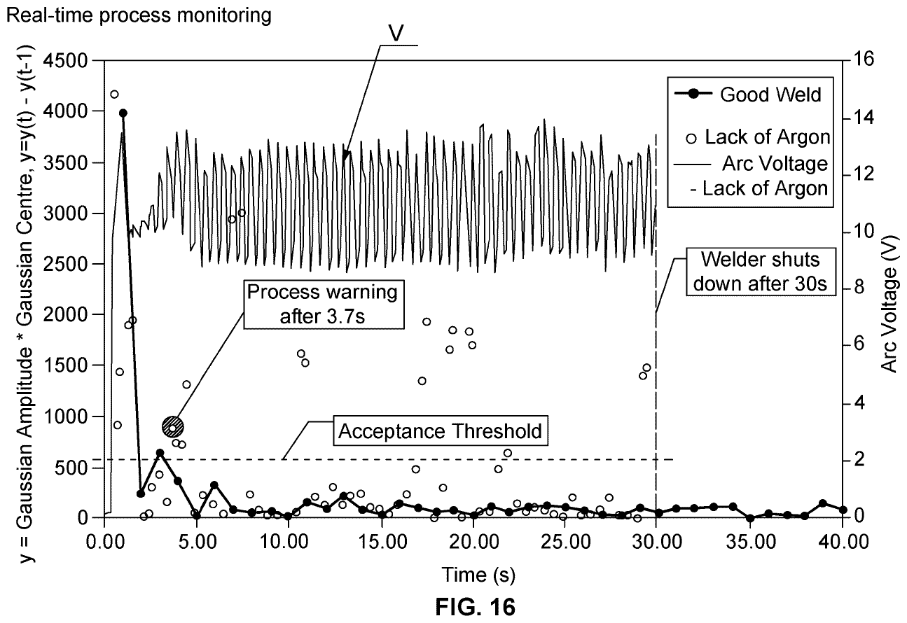

FIG. 16 is a plot of arc voltage and a plot of Gaussian amplitude x Gaussian centre v time for a welding process;

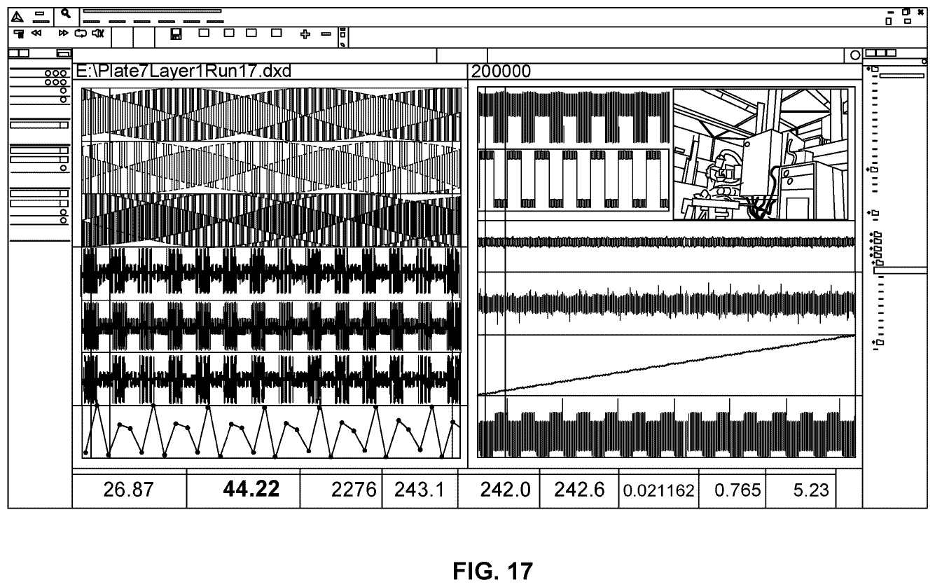

FIG. 17 is an illustration of the combined data types displayed to a user;

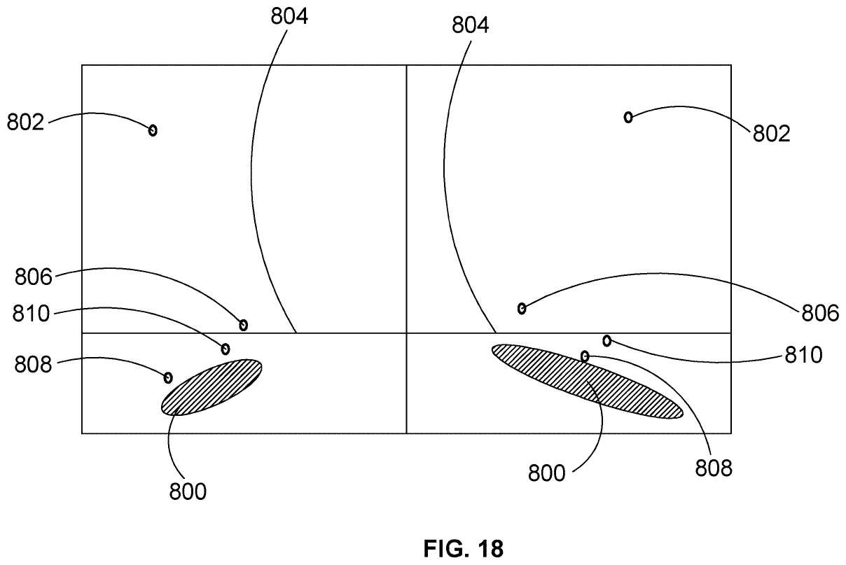

FIG. 18 is an illustration of a second level of processing applied to data from a plurality of sensor types.

Ultrasonic testing is used for the non-destructive testing of a wide variety of test pieces. A transmitting transducer emits ultrasound waves which enter the test piece, interact with the test piece and sub-features thereof, and then return to a receiving transducer. Effective transmission of the ultrasound into the test piece is important, to avoid high levels of reflection at the interface. A liquid coupler is often used to improve transmission at the interface.

When testing welds, after completion of the weld, it is desirable to be able to conduct the ultrasound test soon after the weld has been formed, so as to minimise the time taken to perform, test and then make any corrections needed to the weld. However, liquid couplers, such as water, have clear limits on the temperatures of test piece that they can operate on and so the test piece has to cool to or near to ambient before testing in such cases.

FIG. 1 provides a schematic of a typical prior art process sequence. The schematic provides a process sequence starting from the point in time at which a weld has been completed. Usually, the sequence would be applied after all passes have occurred and the weld is complete, due to the aggregate cooling times that would otherwise arise. In a multi-pass welding situation, this could be conducted after each pass of the weld, but that would be extremely time consuming. Allowing the object to cool between weld passes for inspection purposes is also undesirable as repeated heat, cool, heat, cool cycles can affect the microstructure of the object in undesirable ways.

In the left-hand process sequence, the weld has been completed and in the first step the pre-heating applied to the substrate being welded is turned off. This pre-heating was used to bring the substrate up to the optimum temperature for welding and to maintain that temperature during welding. With the pre-heating off, the substrate cools towards the ambient environment temperature around the substrate in the second step, typically room temperature. A further 24 hour delay may be built in before the testing can take place, particularly in relation to substrates susceptible to hydrogen cracking. Once the substrate has cooled to a sufficiently low temperature for the non-destructive examination, NDT, to take place, then the NDT can be conducted to examine all of the weld, a third step. In this case, no defects are detected and so the weld passes the inspection and the process is completed. As can be seen in the times needed for each step in the process, the substrate has to cool to a relatively low temperature for the NDT to be conducted. Any attempt to conduct the NDT before sufficient cooling could lead to irreparable damage to the ultrasound based NDT device used.

In the right-hand process of FIG. 1, the first three steps are conducted as before with the same time periods needed to conduct them. In this case, a defect in the weld is found in the third step and so remedial action is needed.

In the remedial stage, the first remedial step is to excavate the weld to reach the defect. The time taken will depend upon the depth of the defect and the dimensions of the defect. For instance, a greater period is involved if the defect is in an early weld pass and so multiple subsequent passes need to be excavated. After excavation, a further NDT cross-check is performed, the second remedial step, to ensure that the defect has been found and fully excavated. The substrate is now ready for re-welding.

In the re-welding stage, the pre-heating is turned on as a first re-welding step to gradually raise the temperature of the substrate to the optimum welding temperature. Once that temperature has been reached, then the second re-welding step is to make the weld repair through further welding.

The right-hand process sequence can then return to the NDT stage and its steps, with the pre-heating off, cooling to ambient, further 24 hour wait and NDT conducted. If no defect is present, then the weld passes to the next stage. If a new defect is found then the remedial steps have to be repeated.

As can be seen from the step times in the right-hand process, defect correction can add a very substantial amount of time to the process and reduce efficiency.

The ability for an ultrasound probe to operate successfully at higher temperatures would mean that probe could be used closer to the welding location, in time and in distance. This would include between individual weld passes. This in turn would reduce the time delay between the weld being formed at a location and the detection of any issue with the weld at that location.

This improvement could facilitate faster inspection to detect imperfections and flaws at the point of generation and thus enable remedial work to be commenced sooner. For instance, the flaw could be detected without having to complete all of the passes and without having to wait for the object to cool. Any flaw could be corrected faster as there is less delay than in getting the object down to measurement temperature and then back up to welding temperature afterwards. Furthermore, the extent and time taken for the excavation process is far less, as far less material needs to be excavated to reach the defect. These steps increase throughput, minimising risk and reduce costs.

This improvement could also facilitate more closed loop control and automation to minimise the generation of imperfections and flaws within the welded component. By monitoring the conditions and adapting the control of welding equipment, the system can ensure optimum conditions are maintained.

The ability for an ultrasound probe to operate successfully at higher temperatures allows for a materially different welding and NDT sequence to be conducted. The ability for an ultrasound probe to operate successfully at higher temperatures also allows a materially different welding, NDT and then remedial work sequence to be conducted. Details of a suitable embodiment of a probe are provided at the end of this document.

Referring to FIG. 2 shows an object 1 formed of a substrate 2 being welded at welding location 3 by a welding device 5. A multiple axis robot 7 is also provided with an arm 9 on the distal end 11 of which is a schematically illustrated probe 13. The probe 13 is in contact with a testing location 15 which was recently the welding location. The physical distance D and similarly the time distance is very short and both are in action at the same time. The weld cooling and substrate cooling are only from the welding temperature down to or towards the pre-heating temperature of the substrate 2.

FIG. 3 provides a schematic of a process sequence according to the disclosure. With the substrate 2 at the optimum welding temperature provided by the pre-heating, welding is being conducted at welding location 3 and simultaneously NDT is being conducted at testing location 15. The NDT is conducted without cooling times being provided for the substrate 2 and so in itself adds no testing time to the overall process time, bar a small increment between the welding reaching its final location and the testing reaching that final location a short time afterwards. As shown in FIG. 2, this is a relatively short distance and hence time.

In the upper part of FIG. 3, the process sequence if a defect is detected is shown. In the sequence, the remedial steps are applied. In the remedial steps, the first remedial step is to excavate the weld to reach the defect. The time taken will depend upon the depth of the defect and the dimensions of the defect. After excavation, a further NDT cross-check is performed, the second remedial step, to ensure that the defect has been found and fully excavated. The substrate is now ready for re-welding.

In the re-welding, the re-welding can immediately start as there has been no turning off for the pre-heating and hence no cooling and so no time needed to reheat. The second re-welding step to make the weld repair through further welding can therefore begin without delay. A further NDE can be conducted at the re-welded location to ensure that there is no new defect present and the old one has been fully remedied.

Once all of the welding has been completed and subjected to NDT, and any defects have been remedied, the welding is completed and the substrate can simply enter a cooling sequence. In the first cooling step the pre-heating applied to the substrate being welded is turned off. With the pre-heating off, the substrate cools towards the ambient environment temperature around the substrate in the second cooling step, typically room temperature. This may be the completion of the process, or a final NDT step may be conducted.

The process in FIG. 3 clearly shows from the step times and total times, the very material time savings and hence increased efficiency are achieved compared with FIG. 1 and its process sequence. As well as avoiding the need for various steps, some steps, such as for instance the weld excavation step where only the last weld pass would need excavating, are shorter in their own right, even if they occur.

With both the multiple axis robot 7, provided with its arm 9 and probe 13, and the multiple axis robot for the welding device 5 being autonomously controlled a very wide range of welding and NDT situations can be precisely conducted and tested without user intervention.

Whilst the disclosure above is concerned with reducing the time between welding and NDT, so that any defects can be remediated more quickly, the disclosure also reduces the risks of defect formation through improved initial weld quality. This is achieved by an enhanced range of data sets relating to the welding that are collected, analyzed and employed as the welding progresses.

In the exemplified disclosure, four different sensor types are used to collect data from use in combination and to provide adaptive control capability for the welding and hence mitigate the chance of defect formation.

Referring to FIG. 4, a schematic illustration of the adaptive control capability is provided.

Within the Welding Process, on the left-hand side of FIG. 4, the NDT step [Post Weld Hot NDT] discussed above is conducted using a high temperature compatible roller type ultrasound probe [described in further detail below] and this step provides the ultrasound data [NDT Indications] which are fed to the overall assessment of Weld Qualification which provides the end of the process.

As well as that monitoring of the weld produced and prompting any remedial action on that, the Welding Process leads to a parallel series of steps commencing with Process Monitoring that seek to prevent or minimize the extent of defects arising. The Welding Process is where a series of variables which influence and control the welding are defined and controlled. These may include: wire feed speed, voltage, current, welding speed, welding device to welding location separation, shield gas, shield gas flow rate, substrate shape/profile/configuration/dimensions, pre-heating temperature for the substrate, welding groove shape/profile/configuration/dimensions, weld or weld pass shape/profile/configuration/dimensions.

In the Process Monitoring step, data on the applied voltage and current with time for the welding device 5 is measured and collected.

The data from the five sensor types are feed into the data stream at this point to form the Sensor Data. These are Current, Voltage, Laser, Vision and Acoustic data streams from appropriate sensors described in more detail below. Sensing of weld profile using laser scanning, visual assessment of the weld and acoustic sensing of the sounds originating from the weld are also used in this embodiment to consider correct weld formation, or issues in correct weld formation. Sensing of voltage and current is used in this embodiment to consider correct weld formation, or issues in correct weld formation.

Having collected the data from all of the sensors and hence obtained the necessary data, the data goes through a Data Conditioning step. The Data Conditioning is provided based upon Inputs provided through a User Interface and/or based upon Historic Data obtained from Storage. The Storage may contain data from earlier in this weld's conduct and/or data from a large number of previous welds conducted by the system and/or data from other systems [for instance from calibration processes or the like], all of which can contribute to the Historic Data and hence to the Data Conditioning.

By the application of Data Reduction and/or Machine Learning, Live Analysis of the data is obtained and copies can be fed to the Storage for future use or to contribute to the knowledge of the system and/or similar systems.

A key step in the Analysis Results is the data position compared with one or more thresholds set for the data of that type, Thresholding. The position relative to a threshold may be deemed indicative of a defect, Defect Indicators, and hence be a key part of the Weld Quality Results which in turn are displayed to the user via User Display, which also receives and displays the Sensor Data received. The Weld Quality Results step can, on encountering an unacceptable weld, stop the welding process and/or provide an alert to an operator, for instance via User Display.

Based upon the User Display position, the operator or even the system itself may adjust one or more variable parameters used to control and conduct the Welding Process in real time.

The Weld Quality Results feed through to the Weld Qualification provided for the weld overall. Where a defect is identified by the NDT, then the size and position of the defect are cross-checked with appropriate standards to ensure that the defect is acceptable at that level. If not, remedial action is taken. If acceptable, then a 3D lifetime record of the data is kept within the Weld Qualification so as to be available through the life of the weld and into any necessary decommissioning support.

### Information on High Temperature Substrate Compatible Ultrasound Probe

FIG. 5 is a perspective view of an embodiment of a probe 13. The axis of rotation R-R extends through the probe 13. A first mounting location 20 is provided lying on the axis, together with a second mounting location 22 on the other side of the probe 13. The first mounting location 20 and the second mounting location 22 provide for the mounting of the probe 13 on the robot 7 in a manner which allows for rotation of the probe 13 as it is advanced over the surface of the object 1.

The probe 13 has rigid end structures 24a, 24b at each end and these are provided with bolts 25 to connect them and to provide an annular mounting 26 for the generally cylindrical coupling element 28.

Connected to the first mounting location 20 and extending axially therefrom, is a manifold element 30. The manifold element 30 has a cooling fluid inlet 32, which is connected in use to a cooling fluid feed conduit [not shown], and a cooling fluid outlet 34, which is connected in use to a cooling fluid exit conduit [also not shown].

FIG. 6 is a cross-sectional plan view of the probe of FIG. 5 also showing many of the above features.

Referring to FIG. 7a, a cross-sectional side view of the probe of FIG. 5, the manifold element 30 is fluidly connected to the first mounting location 20. A first fluid connection is formed by first inlet bore section 36 connecting to second inlet bore section 38 which leads via a conduit 40 to the internal volume 42 of the probe 13. A second fluid connection is formed by first outlet bore section 44 connecting to a second outlet bore section [not shown] which leads from the internal volume 42 of the probe 13.

The internal volume 42 extends between the opposing wall sections 46a, 46b of the coupling element 28 and also extends between the opposing internal surfaces 48a, 48b of the rigid end structures 24a, 24b. The internal volume 42, at least to a level above the maximum vertical extent 50 of the transducer 52, is filled with a coolant.

The coupling element 28 is a unitary piece of compliant material, discussed further below. The coupling element 28 is provided with generally right cylindrical main body part 54 and with an inwardly turned rim 56a, 56b at the ends. The rims 56a, 56b are each compressed between an external element 24a and an internal element 24b which form the rigid end structure 24a. The external element 24a and opposing internal element 24b are connected to one another by a series of releasable fasteners, in this case bolts 25.

Thus, as the probe 13 rolls over the surface of the object, different parts of the main body part 54 of the coupling element 28 contact the object and the external element 24a and an internal element 24b which form the rigid end structure rotate too.

The rigid end structure 24a, 24b is free to rotate relative to axial element 64, a continuation of which provides the first mounting location 20. A first shaft type seal 66 and a second shaft type seal 68 allow for the rotation whilst sealing against coolant leakage between the axial element 64 and the rigid end structure 24.

A second axial element 70 is connected to the axial element 64 by a series of releasable fasteners 72. The second axial element 70 provides a mounting for the transducer 52, for an anti-echo block 74 and a ultrasound conveying block 76.

Thus, the transducer 52, anti-echo block 74 and conveying block 76, together with the second axial element 70, the axial element 64 and the first mounting location 20 do not rotate as the probe 13 rolls over the surface of the object. Thus, the transducer 70 and associated components are maintained in the same sensing orientation opposing the object, at all times.

As a result of the abovementioned configuration, when the probe 13 rolls over the surface of the object, there is relative movement between the inside surface 78 of the coupling element 28 and the radial surface 80 of the conveying block 76.

Also mounted on the second axial element 70 is a mounting element 82 that carries a thermistor 84 for temperature sensing of the internal roller probe domain at a location 86 close to the part of the inside surface 78 that abuts the welded location.

As seen in FIG. 8a to 8e, alternative embodiments of the probe 13, transducer 52 and conveying block 76 can be provided. As shown in FIG. 8a, the transducer 52 is mounted on an inclined, axial facing surface 88 of the conveying block 76 by means of fasteners 92. The conveying block 76 is provided with a coolant inlet 93 and a coolant outlet 94. As seen in FIG. 8c, the coolant inlet 93 leads to a serpentine passageway 95 and hence to a coolant feed outlet 96 in fluid communication with the internal volume 42 of the probe 13. A similar structure on the other side of the conveying block 76 extracts coolant from the internal volume, through a coolant withdrawal inlet, to a second serpentine passageway and hence to the coolant outlet 94. These passageways and the configuration of these passageways assists with the cooling of the conveying block 76.

The axial facing surface 88 of the conveying block 76 and/or the radial facing surface 90 of the transducer 52 can be provided with gaps, slots or grooves to aid coolant flow between the two surfaces.

For instance, referring to FIGS. 8c and 8d, the inclined, axial facing surface 88 has an intersection with a second axial facing surface 97, which face 97 is generally parallel to the axis of rotation. The transducer 52 ends close to the intersection. As seen in the detail of FIG. 8d, a channel 98, such as a groove, is provided in the conveying block 76. The channel 98 improves access for coolant to the gap 92 between the axial facing surface 88 of the conveying block 76 and the radial facing surface 90 of the transducer 52. The channel 98 is in fluid communication with a series further grooves 99 in the axial facing surface 88 of the conveying block 76 to further promote coolant flow into the gap 92. The channel 98 and/or further channels 99 could be provided in the transducer 52 and/or in the conveying block 76.

As seen in FIG. 8b and the detailed view of FIG. 8e, the channel 98 extends across the width of the conveying block 76 from one side to the other. The further channels 99 are regularly spaced along the channel 98 and extend along the inclined, axial facing surface 88 away from the channel 98.

In another potential detail, the leading edge 100 and the trailing edge 102, considered relative to the rotation when the probe 13 moves in direction A, of the conveying block 76 are each provided with a chamfer. Thus, as the conveying block 76 effectively moves through the coolant during rotation, the coolant is encouraged by the chamfer on the leading edge 100 towards the gap 108 between the radial facing surface 80 of the conveying block 76 and the inside surface 78 of the coupling element 28. This encourages the continuous presence of the coolant between the radial surface 80 and the inside surface 78, which is very beneficial for the passage of the ultrasound waves across the interface between the conveying block 76 and the coupling element 28. The continuous presence of the coolant is also helpful with cooling of the radial surface 80 too.

The separation of the axis of rotation R-R and the object 1 being probed is such, in use, that the object 1 pushes the coupling element 28 towards the axis and so into good contact with the conveying block 76, with the coupling element 28 being compressed between the object 1 and the conveying block 76.

As can be seen in FIG. 8a, in another potential detail, the axial facing surface 88 of the conveying block 76 has a greater extent along the axis and perpendicular to the axis that the radial facing surface 90 of the transducer 52. As the conveying block 76 and transducer 52 are moved through the coolant by rotation of the probe 13, this geometry encourages coolant into the junction between the conveying block 76 and the transducer 52 and so into the gap 92 therebetween. The flow direction of the coolant into the device along conduit 42 also promotes flow in the direction of the gap 92.

In a still further potential detail, shown in FIG. 9, the radial facing surface 80 of the conveying block 76 is provided with a series of interface channels 300. These are recessed into the curved radial facing surface 80 which faces the inside surface 78 of the coupling element 28 in use. The interface channels 300 extend the full length of the conveying block 76 and extend parallel to the axis, but other extents and profiles can be provided.

The continuous presence of the coolant in the gap 92 between the axial facing surface 88 of the conveying block 76 and the radial facing surface 90 of the transducer 52 is very beneficial for the passage of the ultrasound waves across the interface between them.

With respect to the passage of ultrasound waves, the conveying block 76 is fabricated from polyetherimide, as that offers the desired temperature resistance and capacity to deal with repeated cycles of temperature changes. Furthermore, the material has the necessary acoustic properties to be balanced with the other components.

For monitoring purposes, the thermistor 84 is provided within a further block of polyetherimide, offset to the side of the conveying block 76, so as not to interfere with the conveying block 76 ultrasound propagation role. At the same time, the position of the thermistor 84 is still effective in insuring that the temperature constraints of the components are not approached. If they are, then the probe 13 can be removed from the object to prevent damage of the components. The block providing the thermistor 84 may be attached to the conveying block 76 in other embodiments, and the thermistor 84 could be incorporated into the conveying block 76 in other embodiments.

With respect to the passage of ultrasound waves, the coupling element 28 is a higher temperature compatible silicone rubber. The material selected is able to withstand temperatures in excess of 350° C. for prolonged periods. Such materials can have an attenuation of 0.87 dB/mm at 5 Mhz and an acoustic impedance of 1.12 MRayls and so is a good alignment with the other materials employed.

In terms of the thickness of the coupling element 28, a balance is struck between increasing thickness giving more thermal insulation to the probe contents and increasing thickness causing detrimental increases in attenuation. A thickness of between 4 mm and 8 mm is suitable for such materials in the operating conditions under consideration.

The chosen materials for the coupling element 28 also offer sufficient compliance for it to conform to the surface of the object under moderate applied force levels. High force levels are undesirable in terms of the equipment needed to generate them and still move the device over the test piece. A compliant material is needed to gain good contact for the transmission of the ultrasound, without undue loss, given that the surfaces of the objects encountered in real world situations are not highly finished or smooth.

With respect to the passage of ultrasound waves, the anti-echo block 74 has an important role in preventing ultrasound waves bouncing within the probe and causing noise or other negative impacts upon the probe. Hydrogenated nitrile rubber, HNBR, was found to be a suitable material, particularly N filler forms thereof. This was due to the 6.4 dB/mm attenuation provided at 5 MHz.

All of these features serve to assist with successful acoustically coupling of the probe to the object through the real-world surface encountered.

To assist with the withstanding of the elevated surface temperatures of the object, the coolant circuit for the probe 13 is used.

FIG. 10 shows a schematic for the coolant circuit in one embodiment thereof. A coolant reservoir 100 provides a coolant feed through conduit 102 to pump 104 and second conduit 106 to the cooling fluid inlet 32 provided on the probe 13.

Within the internal volume 42, the coolant is able to freely circulate within the full volume of that internal volume, including around the transducer 52, around the conveying block 76, through the gap therebetween, around the lower parts at least of the coupling element 28 and through the gap 92 between the coupling element 28 and the radial facing surface 80 of the conveying block 76.

Returning to FIG. 10, from the internal volume 42, the coolant exists through cooling fluid outlet 34 and into a third conduit 108. A temperature sensor in the third conduit and/or within the internal volume 40 can be used to ensure cooling is as desired and potentially to control the pump speed to increase or decrease cooling. The third conduit 108 leads to a heat exchanger 110 which provides cooling of the coolant ready for reuse. The fourth conduit 112 takes the cooled coolant from the heat exchanger 110 and returns it to the reservoir 100 ready for reuse.

The use of active cooling for the probe 13 and its elements is beneficial in allowing the probe 13 to be used on hot object surfaces for prolonged periods of time.

Referring to FIG. 11, this shows a first temperature plot 200 and a second temperature plot 202, both against time that the probe in contact with the hot object. The first temperature plot 200 is for a probe 13 according to the disclosure and with circulating coolant. This shows that the approach is successful in maintaining the internal temperature of the probe 13 well within operating limits. The active cooling provides ensures that the transducer is kept below the 55 to 60° C. maximum operating temperatures applicable to most transducers of the desired type.

The second temperature plot 202 is for a probe with similar internal components, but with the coolant volume fixed and limited to that sealed within the internal volume of the probe. The temperature clearly rises with time as heat transfers to the probe and builds up therein, until after a relatively short period of time, the temperature exceeds a reliable operating threshold of 50° C. In practice, such a probe would have to be removed from the object before that threshold of 50° C. was reached and no monitoring could occur until the probe itself had cooled down.

In terms of the coolant, air offers poor thermal capacity and conductivity for active cooling. Water is also a sub-optimal as its acoustic impedance at at 1.5 MRayls is a poor match for the other components. Providing the coolant, in the form of a water-soluble oil, for instance which has an acoustic impedance of 1.1 MRayls and so is a better match with the acoustic impedance of the conveying block [1.1 or so MRayls].

The transducer 52 provides a 5 Mhz 64 element phased array and is mounted to generate 55° ultrasound waves into the object. A 0.5 mm pitch and 10 mm elevation can be used. An angled beam is beneficial in being able to inspect the weld fully from a laterally spaced location. Frequently, that laterally spaced location will be more amenable to good contact between the probe and the object, that at the location where welding is occurring. For instance, in multi-pass welds, until the weld is completed, there will be a significant depression which will interfere with good contact and ultrasound propagation into the object. This is an issue with 0° or low angle-based approaches.

This type of transducer and conveying block configuration can be used to provide a sectorial scan beam defined by the upper extremity beam [angled away from the perpendicular to the transducer face] and the lower extremity beam [near perpendicular to the transducer face] emitted.

In terms of the performance sought for the probe in terms of high temperature performance, the disclosure provides probes that are capable of inspecting for prolonged period objects that are at 300° C.

The coupling is dry but still achieves the necessary levels of ultrasound propagation through the interface into and back from the object.

The high-temperature polymer used in the coupling component is able to withstand prolonged contact with objects at such temperatures and still propagate the ultrasound to and from the interface successfully.

The coolant and hence the coolant filled gaps are able also to effectively propagate the ultrasound waves to and from the conveying block.

Optimal propagation properties for the conveying block are provided as the block is exposed to near ambient temperatures only and so there is no need to choose high temperature resistant materials which have lesser ultrasound propagation properties.

### Information on Use of Multiple Sensor Types

### Welding Location Conditions and Impact

Arc welding uses a power supply to generate sufficient voltage difference between the electrode of the welding device and the substrate to be welded to produce an arc. A current results. The arc heats the substrate to a molten state [potentially with consumption of the electrode]. On cooling, the molten metal solidifies to join two substrates together.

The speed with which the welding device moves relative to the substrate has an impact upon the quality of the weld through impacting upon the extent of melting, shape of the melt pool and the like.

The welding location is usually protected by a shield gas to prevent oxygen, water or water vapour in the atmosphere reaching the welding location. Inert or semi-inert gases are typically used for the shield gases, examples include argon and helium. Flow rates for the shielding gas impact upon its ability to perform its role.

For the quality of the weld to be high, careful control of many operating variables is necessary within the welding process. These variables can be considered indirectly, as exemplified in the section below. Although not directly sensed in the exemplifying embodiment, further sensor types could measure speed of welding device movement, shield gas flow, shield gas flow rate and add those sensor types and their data sets to the processing.

### Acoustic Sensor Type

The acoustic sensor type collects high frequency audio signals that arise as the welding occurs. These come from the arc forming the weld and the interaction of the arc with the substrate and the interaction of the arc with the shield gas. The audio signals detected have been established to be sensitive to a number of important variables within the welding process. Referring to FIG. 13, this shows examples for the values for outlier score for different welding characteristics.

The outlier score is obtained by a mathematical approach which considers how far a particular data value is from known set of data values, which have been classified as acceptable values for the characteristic and/or sensor type data being assessed.

One such approach, used in the disclosure, is the use of a Mahalanbis distance novelty detection model by comparing the incoming audio signal values to the previously developed Principal Component Analysis, PCA, model for the sensor type and its signal values and/or data values.

The signal processing includes taking the audio signal and applying a noise cancelling algorithm to the raw data. The audio signal is further processed by the use of a short-time Fourier transform to convert the raw time series of data into the frequency domain. Statistical features are then extracted from each of a series of bandwidths spanning the frequency range of interest. In the example, the bandwidth used is 39.1 kHz and that yields 312 features describing the acoustic signal in a given instance of the signal. The total feature set [312 features for each signal instance] is then optimised by the removal of redundant features and then standardised to improve the robustness of the features with smaller standard deviations.

In the initial establishment of the PCA model, the signals and hence the remaining feature set arising from the processing above is established to be for acceptable performance of the welding with respect to that variable, in this case acoustic signals. Hence, the remaining feature set can be finally reduced using a PCA to give the model and the principal components that define that model in respect of acceptable performance of the welding.

The PCA model of acceptable performance can then be used to consider subsequent signals. Those subsequent signals are subjected to the same noise cancelling and other steps defined above. For each feature, a feature value position relative to the distribution of feature values for established acceptable weld performance and hence feature values is determined. A mean is calculated for the distribution and the feature value distance is measured relative to the mean. The distance provides the outlier quantification displayed in FIG. 13 and so establishes variations in distance which are still consistent with acceptable welding conditions and establishes variations in distance which are more exceptional and so indicative of impaired welding performance.

The approach is beneficial in giving a unitless, scale-invariant quantification that takes account of the correlation of the feature values within the distribution. The mean can be recalculated as acceptable feature values are added to the distribution and/or the PCA model or can be based upon a fixed set of pre-existing acceptable feature values used in a PCA model.

Referring to the example results obtained using this processing and displayed in FIG. 13, the first set of data points are illustrative of good welding operating parameters occurring. These parameters where independently verified as applying. As can be seen these give a well clustered set of data points A, relative to the log scale outlier score axis.

The second set of data points are illustrative of too high a welding speed; that is the welding device and the substrate are moving too fast relative to one another. Two different welding speed deviations were demonstrated and these give two well clustered sets of data points B¹ and B², with few outliers.

The third set of data points are illustrative of sidewall arcing during welding; that is the arc is short circuiting to the side wall rather than to the desired welding location within the welding groove. Once again, these conditions give a well clustered set of data points C, with few outliers.

The fourth set of data points are illustrative of sidewall fusion; that is the arc is melting the sidewall and causing fusion there rather than in the welding groove. The data points are well clustered as data points D, with few outliers.

The fifth set of data points are illustrative of too high a flow rate for the shielding gas; this can cause porosity issues which are undesirable. As with the other sets of data points, this set E is also well defined with few outliers. A similar position can be detected with too low a flow rate for the shielding gas.

Each of the undesirable welding conditions mentioned, when present, gives a far higher outlier value or feature value than when good welding conditions are present. As a result, a threshold Th^{acoustic} [a selected value for the Mahalabis distance] can be set and can be used to distinguish between acoustic sensor type derived data indicating good welding conditions or indicating impaired welding conditions. Thus, the acoustic data type has the ability to warn the operate, trigger a stop to welding or the like if the threshold Th^{acoustic} is breached or remains breached for a given number of data points. Real-time acoustic signal-based identification of defect generation is thus provided. This analysis can be provided continuously and can be provided for each pass of a multi-pass weld approach.

Significantly, the algorithm used is more complex that just the use of a single previously developed Principal Component Analysis, PCA, model for the sensor type and its signal values and/or data values. As seen in FIG. 14b, in multi-pass welding, the weld passes gradually fill the weld groove. This means that the depth of the weld groove, the shape of the weld groove and the volume filled change with each pass. All of these and potentially other changes between passes impact upon the acoustic signals that are emitted and are detected. Thus, the approach uses a separate model for each pass so as to make the most accurate assessment of the observed data against the expected data for that pass.

The separate models could be obtained by a neural network approach to training based upon pre-existing passes or could be learned as the passes are made during operation with increasing number of each pass improving the model for that given pass in the sequence of passes.

The use of a separate model for each pass also extends to the use of separate models for repasses, for instance as a part of remedial work on the weld. The weld groove shape and hence the acoustics in such repass cases are significantly different from the ordinary passes.

### Laser Sensor Type

The next sensor type employed is a visual one and this seeks to evaluate the geometry of the weld created.

FIG. 14a illustrates a section of substrate 2 with a weld 20 formed on it. The weld 20 is linear in this example, but other weld track can be considered in the same way. A visual sensor type device 22 includes a casing 24 within which is provided a light source 26 which can illuminate the substrate 2 and the weld 20 across an illuminating width 28. The device 22 has an operating range 30 within which accurate imaging is possible. Light returns to the device 22 where a receiver 32 focuses the light onto a senor matrix 34 and signals are generated. In this example a 2D laser profile scanner is used, by other types can be substituted.

The laser as the light source 26 is used to establish various details of the weld and surrounds, including the weld profile, groove profile remaining, weld bead width and any material deposited outside of the weld groove. A plane perpendicular to the substrate surface beside the weld groove and perpendicular to the longitudinal axis of the weld groove may be used for the inspection. In addition, the weld bead profile along the weld groove may be considered.

FIG. 14b is an illustration of a typical welding groove during the course of a sequence of welding passes. Each weld pass adds a weld to the welds already present in the groove, in a predetermined sequence [as numbered] to build up the overall weld. As can be seen, the weld passes contribute a predictable geometry for the weld pass itself and a predictable change in the geometry of the weld groove, if welding is proceeding correctly.

The signals from the device 22 can be used to form a profile image across the weld track with each position along the weld track. That actual profile can be compared with an expected profile and deviation noted. The deviation can be compared with a threshold Th^{profile}. Thus, the profile data has the ability to warn the operate, trigger a stop to welding or the like if the threshold Th^{profile} is breached or remains breached for a given number of data points. Real-time profile signal-based identification of defect generation is thus provided. This analysis can be provided continuously and can be provided for each pass of a multi-pass weld approach. Effective geometric verification is provided.

### Visual Sensor Type

In the next sensing area, a high dynamic range camera is used to obtain images of the welding location, including the location where a weld has not yet been formed, the location where the weld is being formed and the location where the weld is solidifying and then cooling further.

FIG. 15 shows a series of images of this type collected from different weld locations. Processing of these using combinations of artificial intelligence and conventional machine vision tools, the system can detect the changes in the images that correlate to abnormal welding conditions or the generated visual anomalies caused by defects. This may be achieved using the processing of single images, or a combination of multiple images from prior data, both from recent images, and historical parts and passes.

One or more variables may be considered in this area, for instance, the weld pool size [width, trailing length, leading length], weld pool geometry [elliptical, teardrop or others], weld pool temperature can be considered, along with analysis on the patterns, shapes of deposited material and visible anomalies. A profile of known judgement parameters for different types of defects may be used to compare the live outputs from each part of the algorithm against known-good values. These values may be a combination of, presence or absence of a specific visual feature, a numerical band or a threshold value, or a classification. Should the image meet be deemed to exceed these parameters, the situation occurring for one or more or all of those can be compared with the desired position for one or more or all of those and a deviation can be used again to trigger a warning or stopping of the welding.

### Voltage and Current Sensor Type

The voltage applied will impact upon the formation of the arc and the current within the arc. That in turn impacts the power and hence the rate of melting of the substrate [and if consumed the electrode]. These are important variables for the quality of the weld. These are variables which impact the weld pool size for instance.

The welding voltage also needs to be automatically and continuously adjusted to reflect the separation between the welding device and the substrate being welded. This is based upon the known and fixed position of the substrate and the variable but known X-Y-Z position of the robotic arm carrying the welding device, and hence the separation of the two.

The sensing system for the voltage and current monitoring is orders of magnitude faster than that incorporated in pre-existing automatic voltage control approaches. The power system is able to handle 500 A and scale up to 1000 A or more, whilst still providing voltage monitoring and current monitoring at the nano-second level between measurements. Hence, very detailed information of the voltage and current are obtained and even short-lived variations can be taken into account.

Input voltage and current, and hence input power, tends to be detected rather than output power to avoid the sensing/detecting itself disrupting the output power performance.

The data and hence the approach used for its processing is similar to that set out above for the acoustic sensor type.

Referring to FIG. 16, the arc voltage is plotted against time as plot V. In this example, the welding process was shut down after 30 seconds and so the voltage returns to zero.

Also plotted in FIG. 16 is the value for Gaussian amplitude x Gaussian centre versus time. As can be seen, in the initial time period, the first 2 or 3 seconds, the value for this plot is higher than an acceptance threshold and so there would be concerns at the quality of the weld. After that initial 2-3 seconds, and certainly after 8 seconds onwards, the plot is appreciably below the threshold and quality welding is being indicated with respect to this variable set.

In addition to these variables, FIG. 16 also includes indications of when low argon as the shield gas is present. The indication shows the occurrence of low argon by being a plot point and also shows the extent to which the argon is missing through the vertical position of the plot point.

### Overall Process—Continued

Returning again to FIG. 4, having established the specifics by which the sensor types operate and their data is considered, the process and the data within it goes through a Data Conditioning step. The Data Conditioning is provided based upon Inputs provided through a User Interface and/or based upon Historic Data obtained from Storage. The Storage may contain data from earlier in this weld's conduct and/or data from a large number of previous welds conducted by the system and/or data from other systems [for instance from calibration processes or the like], all of which can contribute to the Historic Data and hence to the Data Conditioning.

In the Live Analysis step two different levels of processing may be implemented.

The first level of processing provides for the synchronization of data types from different sensor types. This synchronization can accommodate not only the different data types from the different sensor types exemplified above by means of the different sensor types, but also any number of other sensor types introduced and used to measure key characteristics relating directly and/or indirectly to the welding system and the welds arising.

A Programmable Logic Controller, PLC, is used to temporally synchronize the different data types by the provision of a master timestamp at the initiation of data collection from the sensor types within the system. The PLC also continually checks that each sensor of each sensor type within the system is continuing to provide data and that the data provided is collected at a consistent rate. Periodic further master time stamps may be applied during the data collection process as it progresses.

The master timestamp means that the data collected from the microphones acting as the sensor type for the acoustic analysis, input power analysis to measure the draw during welding, area scan cameras to provide the vision system and laser profile scanner which provides the 3D profile sensor type can all being aligned to represent data from the same time and hence the same position within the weld.

Significantly, the PLC also receives data from an incremental encoder which provides position data. The encoder can be mounted on the substrate being welded and/or on the welding device and indicates the physical position of that encoder at that time. The encoder triggers data collection and provide consistent correlation of sensor data to the weld position on the component. Again, the data from the encoder has the same master timestamp applied. This means that the actual position is known for the established same position applicable at the same time in the alignment of the synchronized data. The data is synchronized temporally and spatially.

This processing enables the sensor data that is collected at different locations on the component to be post processed into one cohesive data structure, with the raw sensor data, the post processed information and the output of the analysis to be correlated to the physical position of the weld. This data can then be displayed to the operator within the user display, allowing them to make adjustment to the welding process based on the output of the system.

The second level of processing is implemented by the application of Data Reduction and/or Machine Learning. This second level of processing takes this correlated data and then feeds it to a secondary layer of processing and analysis (by use of machine learning or other appropriate analysis method) to correlate any number of features from both the raw data and the output of the sensor type level analysis to welding defects. In effect, a machine learning supported decision engine is employed.

Within the method, a general assessment is being made as to whether, where a defect is suspected of a location, that defect is within acceptable characteristics, such as size, or exceeds those acceptable characteristics and is thus a defect that needs noting or remedial action. When NDT type sensing is conducted, then a direct measurement of the defect is made by virtue of the imaging conducted. This reports directly on the size and potentially other characteristics of the defect. However, where the consideration of defects is based upon the welding conditions occurring during the welding, the potential defects are being considered indirectly; the question “are these conditions likely to lead to a defect?” is being considered. The second level of processing offers to make improved determinations on acceptable and/or unacceptable welding in this context.

Referring to FIG. 18, two different sensor types are being considered, Type A on the left-hand side and Type B on the righthand side. The two sensor types could be any of the sensor types mentioned herein and/or other forms of sensor type which provide data on the weld's conduct or weld outcome.

Referring to the Type A sensor type, there will be a series of data points within area 800 which are firmly established as indicative of acceptable welding. These may be established from test runs verified by other sensing and/or NDT or may be modelled cases.

There will also be data points from welding, such as data point 802, which are clearly outside of that acceptable area and also a long way on the unacceptable side of a threshold 804 that may be applied in making a first determination on whether a data point is indicative of acceptable or unacceptable welding. Other data points, such as data point 806, are above the threshold and also deemed unacceptable with that definition of the threshold 804.

The difficult to interpret instances are data points, such as data points 808 and 810, which are outside the area 800 but under the threshold 804. A call based upon the single sensor would result in these being deemed acceptable welding as they are below the threshold.

Gains are to be made by the second level of processing which considers the data points [802, 806, 808, 810] across more than one sensor type to reach the full determination. Referring to the righthand side and the Type B sensor type, the data point 802 again lies within the established acceptable welding area 800. Similarly, the data point 806 is well beyond the threshold 804 and once again from this sensor type alone is indicative of unacceptable welding.

Turning to the data points 808 and 810, again, both are outside of area 800, but under threshold 804. Under a single sensor type approach, these edge cases, would again be deemed acceptable welding. However, the second level of processing obtains additional information by considering the position across the multiple sensor types.

Two approaches to the consideration of the position across multiple sensor types can be employed using neural networks. These two approaches can be used as alternatives to one another or one may be use in parallel or used in series with the other.

In the first approach, labelled data is provided and supervised learning is involved. The labelled data can come from either or both of two sources. Firstly, particularly during an early stage of the processing, for instance during calibration or during early production welding runs, the labelled data may be obtained from experimental results. So, continuing with the FIG. 18 example, the position for both points 808 and 810 may be flagged to an operator for an operator-based assessment of acceptable or unacceptable. The operator is provided not just with the data from a single sensor type to consider and make a call on, but rather is provided with flagged data from multiple different sensor types on that data [data points or a sequence of data points] and so a more nuanced position from which to make a determination call. The outcome is used to label the data and is thus available within the pool of data that the neural network learns from. The human knowledge and interpretation are fed to the neural network by the user's determination and so the supervision is provided.

The second manner for providing the labelled data is to make use of a library of existing data. Again, this data is labelled as to the determination and has the necessary transfer of operator knowledge. The library would be fed to a neural network classifier to establish the processed position for the library data set. The library would cover data from multiple sensor types and thus allow determinations of the second level of processing type; the data point position across multiple sensor type inspection and results. A classifier score could then be determined for any data point relative to that classifier library data and in turn a probable error for a data point [or series thereof] to be examined and a determination to be made on could be quantified. Classifiers can use Bayes theorem-based approaches for the classification and the error quantification.

The second manner, the library, may be used as the starting labelled data set. The conduct of the first manner, calibration or test runs on the actual welding system with operator calls, can be used as an alternative from the outset. However, the first manner can be used to add to the second manner data set and so advance the neural network learning from a more general welding system position to a position more tailored to that particular welding system.

Returning to FIG. 18, the operator might determine data point 808 to be sufficiently close to the acceptable area 800 to be deemed acceptable but might deem the data point 810 so close to the threshold across the multiple sensor types that it is not acceptable. That might lead to the neural network providing a minor adjustment to the acceptable area 800 and/or the threshold 804 [value or format]. Overtime, repeated determinations of this type could lead to a more pronounced and optimised revision of the bounds of the acceptable area 800 and/or of the threshold 804. For instance, the acceptable area 800 might be expanded and/or the threshold might be tightened. The same results as data points 808 and 810 at a later more advanced learning stage for the process might be called acceptable and unacceptable respectively because of where they sit, within the revised acceptable area for data point 808 and over the revised threshold for data point 810.

An example of such an analysis in a real-world scenario might be that the left-hand side relates to a visual image sensor type and one or more images in succession suggest that there is an issue with side wall proximity for the welding. Consideration of an acoustic sensor type as the right-hand side could also suggest a side wall proximity issue and thereby verify an overall determination that the welding was not acceptable.

Whilst the above examples refer to the position from a sensor type and other sensor types giving a determination of acceptable or not acceptable, the determination may be more detailed than that and give a determination of the nature of the problem with the welding conditions. Thus, the data from two sensor types may inform on the nature of the problem, when the data from one sensor type alone might just suggest a problem.

An issue to note, is that the importation of historical data from other welding situations and environments is not a strong starting place for a library from which to judge acceptable welding performance. This is because other welding operations and other welding environments have a wide range of other variables which could have affected the data from those welding operations. For instance, in the context of the visual imaging type sensor, the lighting and lighting angle in that welding environment, the nature of the substrate, the welding torch angle and separation and the like can all influence the data and so that data would not be consistent with that to be looked for in another environment with different lighting, for example.

As an alternative, or additional to this first approach using labelled data and supervised learning, it is possible to reduce or avoid the need for library type data and/or supervised learning, by making use of the ability of neural networks to conduct clustering or grouping based processing [looking for similarities and/or anomalies in the data]. Various techniques, such as K-means clustering exist which enable centroids for clusters to be established and degrees of certainty with distance established around those. Multiple other clustering approaches apply. These could be sued to establish the acceptable area 800 and/or threshold 804 position and modify it with increased data and learning, without the need for a large library of labelled data to start with.

As mentioned previously, the first approach and second approach can be used in combination with one another, as well as being alternatives. Thus, the first approach could be used to start the neural network off on its learning and then the second approach could take over after the first approach has advanced the learning. It is also possible for the neural network to be learning from both the first approach and the second approach at the same time so as to maximise the data fed, particularly where the library is being extended from ongoing welding in other welding systems besides the particularly welding system under consideration. It would also be possible to pool the learning from similarly configured and operated welding systems.

Overtime, particularly when the method is used in production version conducting large amounts of welding, then the amount of data, the precision of the assessments and the complexity of different cases for the data which can be successfully assessed increases.

Any and all of the outcomes from the Live Analysis of the data and/or Data Reduction and/or Machine Learning, once obtained can have copies fed to the Storage for future use or to contribute to the knowledge of the system and/or similar systems.

A key step in the Analysis Results is the data value or position compared with one or more thresholds set for the data type, Thresholding. Examples of approaches on thresholding are provided in the different sections on the specific sensor types exemplified, but are broadly applicable to each sensor type and the data type it generates. The position relative to a threshold may be deemed indicative of a defect, Defect Indicators, and hence be a key part of the Weld Quality Results which in turn are displayed to the user via User Display, which also receives and displays the Sensor Data received.

FIG. 17 is an example of a User Display. The User Display can give the real time output of all of the sensor type analysis allowing them to review the welding process as it occurs and adjust the process if the output of the analysis flags any welds of poor quality. In addition, they will be able to review the overall weld data after each pass and interrogate the data to discern any areas that require remediation or adjustment before or during the following welding to occur.

The Weld Quality Results step can, on encountering an unacceptable weld, stop the welding process and/or provide an alert to an operator, for instance via User Display.

Based upon the User Display position, the operator or even the system itself may adjust one or more variable parameters used to control and conduct the Welding Process in real time.

The Weld Quality Results feed through to the Weld Qualification provided for the weld overall. Where a defect is identified by the NDT, then the size and position of the defect are cross-checked with appropriate standards to ensure that the defect is acceptable at that level. If not, remedial action is taken. If acceptable, then a 3D lifetime record of the data is kept within the Weld Qualification so as to be available through the life of the weld and into any necessary decommissioning support.

### Processing and Storage of Data

In addition to the consideration of each data type individually, there are further advantages to be gained from considering the data types as a combined data stream. To enable this, each of the data sets is time stamped and so that allows all of the data sets to be time synchronised by synchronising the time stamps.

This means that all of the data sets can be combined and then saved as a single data file. This also provides for reuse at a subsequent time.

1. A method of welding, the method of welding including inspection of a weld formed by the method of welding, the method of welding comprising:
i. providing welding apparatus;
ii. providing weld inspection apparatus;
iii. introducing one of more substrates to be welded to the welding apparatus;
iv. elevating the temperature of the one or more substrates above ambient temperature using heating;
v. conducting welding of the one or more substrates at an elevated temperature above ambient temperature using the welding apparatus;
vi. inspecting the weld generated using the weld inspection apparatus;
wherein the inspecting of the weld is provided by the inspection apparatus at an inspection location on the one or more substrates, with the inspection location at an elevated temperature above ambient.

2. A method according to claim 1, wherein the weld inspection apparatus uses ultrasound and the welding apparatus is in physical contact with the inspection location.

3. A method according to claim 1, wherein the inspecting of the weld is provided with the inspection location at an elevated temperature above ambient, and wherein the elevated temperature is at least 80° C. above ambient.

4. A method according to claim 1, wherein the inspecting of the weld is provided with the inspection location at an elevated temperature above ambient, and wherein the elevated temperature is at least 180° C. above ambient.

5. A method according to claim 1, wherein the inspecting of the weld is provided with the inspection location at an elevated temperature above ambient, and wherein the elevated temperature is at least 250° C. above ambient.

6. A method according to claim 1, wherein the inspecting of the weld is provided with the inspection location at an elevated temperature above ambient, and wherein the elevated temperature is at least 350° C. above ambient.

7. A method according to claim 1, wherein ambient is 20° C.+/−10° C.

8. A method according to claim 1, wherein the welding is conducted at a welding location when inspecting is conducted at the inspection location, wherein the welding location and the inspection location are less than 2 m apart along the weld.

9. A method according to claim 1, wherein the welding is conducted at a welding location when inspecting is conducted at the inspection location, wherein the welding location and the inspection location are less than 1 m apart along the weld.

10. A method according to claim 1, wherein the welding is conducted at a welding location when inspecting is conducted at the inspection location, wherein the welding location and the inspection location are less than 0.2 m apart along the weld.

11. A method according to claim 1, wherein the welding is conducted at a welding location when inspecting is conducted at the inspection location, wherein the inspecting location was a welding location less than 10 minutes previously.

12. A method according to claim 1, wherein the welding is conducted at a welding location when inspecting is conducted at the inspection location, wherein the inspecting location was a welding location less than 5 minutes previously.

13. A method according to claim 1, wherein the welding is conducted at a welding location when inspecting is conducted at the inspection location, wherein the inspecting location was a welding location less than 3 minutes previously.

14. A method according to claim 1, wherein welding is conducted at a welding location and the welding location is at a temperature of at 800° C. during welding.

15. A method according to claim 1, wherein the elevating the temperature of the one or more substrates above ambient temperature provides the one or more substrates at a temperature of at least 110° C.

16. A method according to claim 1, wherein the elevating the temperature of the one or more substrates above ambient temperature provides the one or more substrates at a temperature of at least 180° C.

17. A method according to claim 1, wherein the elevating the temperature of the one or more substrates above ambient temperature is provided by pre-heating the one or more substrates before welding starts.

18. A method according to claim 1, wherein if the inspecting indicates a defect in the weld at a defect location, one or more remedial steps are taken on the weld at the defect location, and wherein the remedial step[s] are provided with the defect location at an elevated temperature above ambient, and wherein the elevated temperature is at least 180° C. above ambient.

19. Apparatus for conducting a method of welding including inspection of a weld formed by the method of welding on a substrate, the apparatus comprising:
i. welding apparatus;
ii. weld inspection apparatus, wherein the weld inspection apparatus includes an ultrasound emitter and receiver, the weld inspecting apparatus is provided with a substrate contact surface, wherein the substrate contact surface has a melting temperature above 250° C.

20. Apparatus according to claim 19, wherein the ultrasound emitter and the receiver are provided in weld inspection apparatus, and the substrate contact surface is adapted to roll across the substrate.

21. Apparatus according to claim 19, wherein the ultrasound emitter and the receiver are provided in weld inspection apparatus that is provided with internal cooling.

22. A method of welding, the method of welding comprising:
a) providing welding apparatus;
b) providing a plurality of sensor types;
c) defining a first set of welding conditions for the welding method;
d) introducing one of more substrates to be welded to the welding apparatus;
e) conducting welding of the one or more substrates;
f) obtaining data from the plurality of sensor types during welding;
g) comparing the obtained data from the plurality of sensor types with reference data for one or more of the sensor types;
h) based upon one or more such comparisons, determining whether the welding is of acceptable quality or unacceptable quality;
i) where, if the welding is of unacceptable quality, the method includes then taking one or more actions.

23. A method according to claim 22, wherein at least one sensor type of the plurality of sensor types is a part of weld inspection apparatus and the method includes a step of inspecting the weld using the weld inspection apparatus.

24. A method according to claim 22, wherein the method includes a step of inspecting the weld using weld inspection apparatus to determine one or more characteristics of a defect.

25. A method according to claim 24, wherein the characteristics include one or more of size, position, defect type, defect shape or defect position relative to the geometry of the weld and/or relative to the length of weld with reference to the geometry of the weld and/or relative to the length of weld.

26. A method according to claim 24, wherein the method further includes a comparison of one or more of the characteristics with one or more standards, and further includes a determination of whether the weld with the defect meets a weld standard or does not meet the weld standard.

27. A method according to claim 26, wherein if the weld meets the weld standard, then a record for the weld is created and stored.

28. A method according to claim 27, wherein the method further includes that the record includes data from one or more of the plurality of sensor types.

29. A method according to claim 26, wherein if the weld does not meet the weld standard, one or more remedial steps are applied to the weld.

30. A method according to claim 22, wherein at least two sensor types of the plurality of sensor types are weld conditions sensors and the method includes a step of inspecting the weld conditions using the weld condition sensors.

31. A method according to claim 30, wherein the method includes a step of inspecting the weld conditions to determine one or more parameters of the weld as it is formed.

32. A method according to claim 31, wherein the method further includes a comparison of one or more of the parameter with one or more control parameters, and further includes a determination of whether a risk level for weld defects is exceeded.

33. A method according to claim 22, wherein the method further includes the one or more actions being to alter the welding conditions from the first set of welding conditions for the welding method.

34. A method according to claim 33, where the alteration in the welding conditions from the first set of welding conditions is to stop welding and/or alert an operator.

35. A method according to claim 33, wherein the alteration in the welding conditions from the first set of welding conditions is to change the welding conditions back to the first set of conditions and/or to change the welding conditions to a second set of conditions.

36. A method according to claim 22, wherein at least two of the sensor types are selected from: voltage sensors, current sensors, welding arc sound emission sensors, weld topology sensors, weld imaging sensors and ultrasound imaging sensors.

37. Apparatus for monitoring welding, the apparatus comprising:
a) a plurality of sensor types;
b) a control unit for receiving a first set of welding conditions for the welding method;
c) a comparator for receiving and comparing data from the plurality of sensor types and reference data for one or more of the sensor types;
wherein the comparator outputs a determination on whether the welding is of acceptable quality or unacceptable quality based upon the compared data; and wherein, if the determination is that the welding is of unacceptable quality, the apparatus further provides a control signal to trigger one or more actions by the apparatus.

38. Apparatus according to claim 37, wherein the apparatus includes weld inspection apparatus to determine one or more characteristics of a defect.

39. Apparatus according to claim 38, wherein the apparatus further provides the comparator includes a first comparator for receiving and comparing one or more of the characteristics with one or more standards, and wherein the first comparator outputs a first determination on whether the weld with the defect meets a weld standard or does not meet the weld standard.

40. Apparatus according to claim 37, wherein the apparatus further provides the comparator includes a second comparator for receiving and comparing one or more of the parameters of the weld as it is formed with one or more control parameters, and wherein the second comparator outputs a second determination on whether a risk level for weld defects is exceeded.

41. Apparatus according to claim 38, wherein if a risk level for weld defects is exceeded that a control signal provided by the apparatus is sent to a controller to trigger one or more actions, and wherein the one or more actions is to alter the welding conditions from the first set of welding conditions for the welding method, for instance, to stop welding and/or alert an operator.
